(19) United States
(12) Patent Application Publication
(10) Pub. No.: US 2015/0006218 A1
(43) Pub. Date: Jan. 1, 2015

(54) SYSTEM AND METHOD FOR COMPOSING MEETING INVITES IN ACCORDANCE WITH BUSINESS RULES

(71) Applicant: Avaya Inc., Basking Ridge, NJ (US)

(72) Inventors: Reinhard Klemm, Basking Ridge, NJ (US); Parameshwaran Krishnan, Basking Ridge, NJ (US); Doree D. Seligmann, New York, NY (US); Navjot Singh, Denville, NJ (US)

(21) Appl. No.: 13/928,608

(22) Filed: Jun. 27, 2013

(51) Int. Cl. G06Q 10/10

(52) U.S. Cl. CPC G06Q 10/1095
USPC 705/7.19

(57) ABSTRACT

The present disclosure is related to a meeting scheduling system that can apply an enterprise rule to determine one or more requirements for a scheduled meeting.

### FIELD

The disclosure relates generally to enterprise communications and particularly to structuring meetings in accordance with one or more business rules, policies, and/or requirements.

### BACKGROUND

Meetings are currently scheduled via tools like Outlook™ by Microsoft™ Outlook™ includes a scheduling assistant that assists in determining email addresses and availability of the participants to participate in the meeting and enables a meeting organizer to mark participants as required, optional, etc. While helpful, the scheduling assistant requires that the meeting organizer knows who to invite to the meeting. Often, this knowledge cannot be assumed or the meeting organizer may make suboptimal decisions as to whom to invite or may ignore standard and/or best practices in the business.

An example illustrates these limitations. A corporate meeting between a software development team and a customer needs to be scheduled to discuss a problem with the developer's software at the customer site. The development team may not be aware that its company requires the presence of an in-house lawyer at such meetings. The business may also consider it standard operating procedure (“SOP”) to have a product manager present at the meeting, which is also something that the developers may not be aware of. Alternatively, they may decide to ignore the SOP because it is easier to schedule and conduct the meeting in the absence of a pesky product manager. If the customer were to deploy the software in the cloud and the developers are not cloud experts, it may be desirable to have cloud and software security experts attend the meeting. Even if the developers were to have good intentions to adhere to business rules, policies, best practices, SOPs and other requirements when setting up the meeting, they may fall short. They may make mistakes when setting up the meeting, not know who are the best candidates for the cloud experts, be unaware of one or more pertinent business rules, policies, best practices, SOPs or other requirements, be under time pressure when issuing the invite, shy away from the hassle of locating the correct participants, or be lazy. The end result is a meeting conducted in violation of a pertinent business rule, policy, best practice, SOP or other requirement.

### SUMMARY

These and other needs are addressed by the various aspects, embodiments, and/or configurations of the present disclosure. The present disclosure can provide a meeting scheduling system that can apply an enterprise rule to determine one or more requirements, options, and/or recommendations for a scheduled meeting.

A method, system, and instructions stored on a computer readable medium can perform steps/operations including:

(a) determining that a meeting is currently or will be scheduled by a meeting organizer;

(b) applying one or more enterprise rules to determine one or more of (A) a required and/or recommended invitee, (B) a scheduling parameter for the meeting, and (C) an enterprise resource for the meeting; and

(c) requiring and/or requesting the meeting be scheduled to include the (A) required and/or recommended invitee, (B) a scheduling parameter for the meeting, and/or (C) enterprise resource for the meeting.

The one or more the enterprise rules can be one or more of a business rule, policy, goal, best practice, standard operating procedure, and legal consideration and/or requirement. Commonly, the enterprise rule(s) regulate, require, prohibit, or otherwise control an interpersonal interaction.

The scheduling parameter can be one or more of a required and optional meeting location, timing of meeting, conduct of meeting, and prerequisite for the meeting.

The enterprise resource can be one or more of inanimate enterprise resources available for conferences or meetings. For example, the enterprise resource can be one or more of a required and/or optional enterprise media and multimedia material, desktop sharing service, conference room, office, conference bridge, catering service, conference room setup service, heating, ventilation, and/or air conditioning resource, lighting resource, security resource, information technology resource, conference room accessory device, parking space, and furniture.

The method, system, and/or stored instructions can determine the enterprise rules that apply to the meeting based on a purpose of the meeting.

The method, system, and/or stored instructions can provide the meeting organizer with one or more of a required and/or optional meeting invitee, a list of potential purposes for the meeting, a required and/or optional start and/or end time for the meeting, a required and/or optional inanimate enterprise resource for the meeting, and a required and/or optional location for the meeting.

The meeting organizer can be required to provide a rationale for not selecting the (A) required and/or recommended invitee, (B) a scheduling parameter for the meeting, and/or (C) enterprise resource for the meeting.

The method, system, and/or stored instructions can provide the meeting organizer with a rationale for selecting the (A) required and/or recommended invitee, (B) a scheduling parameter for the meeting, and (C) enterprise resource for the meeting.

The present disclosure can provide a number of advantages depending on the particular aspect, embodiment, and/or configuration. The disclosure can combine a meeting scheduling system, such as Microsoft™ Outlook™, with enterprise rule application to align meeting configurations at or after setup time with relevant enterprise rules. The alignment concerns not only required and optional meeting invitees but also other meeting configuration parameters. It can step a meeting organizer through the process of configuring a meeting in accordance with enterprise rules. This can be done in a convenient, fully or partially automated, error-free, and quick manner that complies fully with enterprise rules. It thus ensures compliance with pertinent enterprise rules regarding the choice of invitees, meeting scheduling parameters, and enterprise resources (e.g., conference bridges, phone numbers, preparatory reading materials, and legal documentation to be filled out before the meeting).

These and other advantages will be apparent from the disclosure.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any storage and/or transmission medium that participate in providing instructions to a processor for execution. Such a medium is commonly tangible and non-transient and can take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

A “database” is an organized collection of data held in a computer. The data is typically organized to model relevant aspects of reality (for example, the availability of specific types of inventory), in a way that supports processes requiring this information (for example, finding a specified type of inventory). The organization schema or model for the data can, for example, be hierarchical, network, relational, entity-relationship, object, document, XML, entity-attribute-value model, star schema, object-relational, associative, multidimensional, multivalue, semantic, and other database designs. Database types include, for example, active, cloud, data warehouse, deductive, distributed, document-oriented, embedded, end-user, federated, graph, hypertext, hypermedia, in-memory, knowledge base, mobile, operational, parallel, probabilistic, real-time, spatial, temporal, terminology-oriented, and unstructured databases.

“Database management systems” (DBMSs) are specially designed applications that interact with the user, other applications, and the database itself to capture and analyze data. A general-purpose database management system (DBMS) is a software system designed to allow the definition, creation, querying, update, and administration of databases. Well-known DBMSs include MySQL™, PostgreSQL™, SQLite™, Microsoft SQL Server™ Microsoft Access™, Oracle™, SAP™, dBASE™, FoxPro™, and IBM DB2™. A database is not generally portable across different DBMS, but different DBMSs can inter-operate by using standards such as SQL and ODBC or JDBC to allow a single application to work with more than one database.

The terms “determine”, “calculate” and “compute,” and variations thereof, as used herein, are used interchangeably and include any type of methodology, process, mathematical operation or technique.

The term “electronic address” refers to any contactable address, including a telephone number, instant message handle, e-mail address, Universal Resource Locator (“URL”), Universal Resource Identifier (“URI”), Address of Record (“AOR”), electronic alias in a database, like addresses, and combinations thereof.

An “enterprise” refers to a business and/or governmental organization, such as a corporation, partnership, joint venture, agency, military branch, and the like.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The term “media” of “multimedia,” as used herein, refers to content that may assume one of a combination of different content forms. Multimedia can include one or more of, but is not limited to, text, audio, still images, animation, video, or interactivity content forms.

The term “module” as used herein refers to any known or later developed hardware, software, firmware, artificial intelligence, fuzzy logic, or combination of hardware and software that is capable of performing the functionality associated with that element.

A “server” is a computational system (e.g., having both software and suitable computer hardware) to respond to requests across a computer network to provide, or assist in providing, a network service. Servers can be run on a dedicated computer, which is also often referred to as “the server”, but many networked computers are capable of hosting servers. In many cases, a computer can provide several services and have several servers running Servers commonly operate within a client-server architecture, in which servers are computer programs running to serve the requests of other programs, namely the clients. The clients typically connect to the server through the network but may run on the same computer. In the context of Internet Protocol (IP) networking, a server is often a program that operates as a socket listener. An alternative model, the peer-to-peer networking module, enables all computers to act as either a server or client, as needed. Servers often provide essential services across a network, either to private users inside a large organization or to public users via the Internet.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a communication system in accordance with embodiments of the present disclosure;

FIG. 2 is a screenshot of a display in accordance with embodiments of the present disclosure; and

FIGS. 3A-B are a flow diagram depicting logic in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

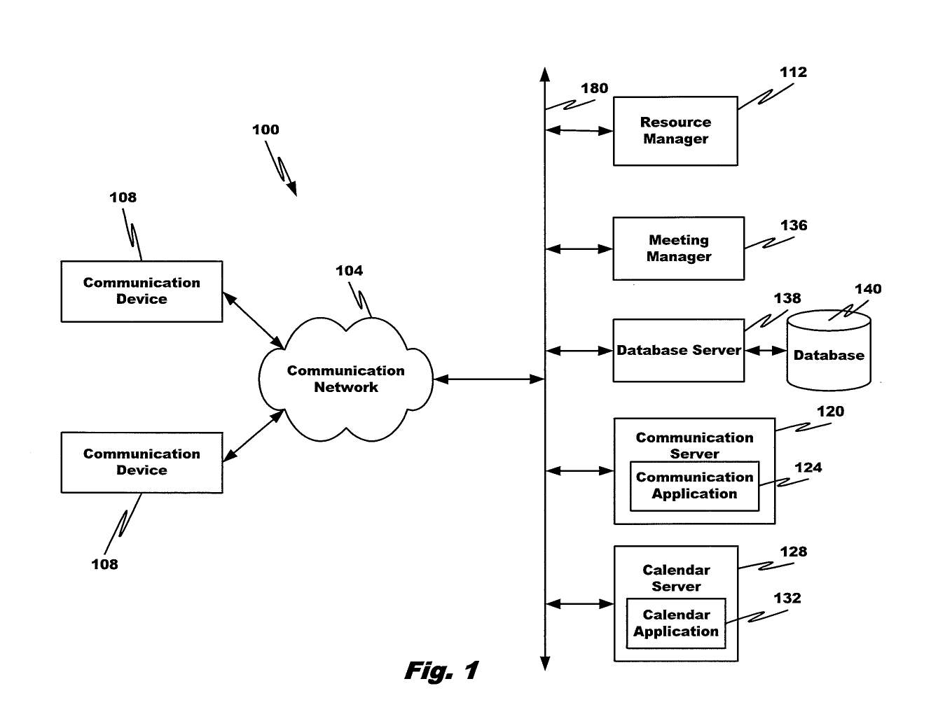

FIG. 1 shows an illustrative embodiment of an enterprise communication system 100 in accordance with at least some embodiments of the present disclosure. The communication system 100 generally comprises a communication network 104, one or more communication devices 108, a communication server 120 including a communication application 124, a calendar server 128 including a calendar application 132, a database server 138 and associated enterprise database 140, a meeting manager 136, and a resource manager 112.

The communication network 104 may comprise any type of known communication medium or collection of communication media and may use any type of protocols to transport messages between endpoints. It may be trusted and/or untrusted. It may include wired and/or wireless communication technologies. The Internet is an example of the communication network 104 that constitutes an Internet Protocol (IP) network including many computers, computing networks, and other communication devices located worldwide, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type, and instead may be comprised of a number of different trusted and/or untrusted networks and/or network types. Moreover, the communication network 104 may comprise a number of different communication media such as coaxial cable, copper cable/wire, fiber-optic cable, antennas for transmitting/receiving wireless messages, and combinations thereof.

The communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, tablet computer, or combinations thereof. In general each communication device 108 may be adapted to support video, audio, text, and/or data communications with other communication devices 108 as well as one or more of resource manager 112, meeting manager 136, database server 138, communications server 120, and/or calendar server 128. The type of medium used by the communication device 108 to communicate with the resource manager 112, meeting manager 136, database server 138, communications server 120, and/or calendar server 128 may depend upon the communication applications available on the communication device 108. The communication devices 108 may correspond to user and/or enterprise subscriber communication devices.

Any of the database server 138, communications server 120, and/or calendar server 128 may comprise a dedicated microprocessor that functions to provide services to client devices (e.g., communication devices 108). The calendar server 128 may work in conjunction with the communication server 120, particularly when acting as an email sever, to provide scheduling, business rule application, and resource management capabilities to the communication devices 108. In other words, a user of the communication device 108 may employ various applications on the database server 138, communications server 120, and/or calendar server 128 to configure and schedule meetings in accordance with one or more selected enterprise rules.

The communication server 120 may employ one or more communication applications 124. Communication applications typically involve interactions between communication servers, devices, and people. Examples of communication applications 124 provide one or more of the following services email, instant messaging, analog, digital, or voice-over-IP telecommunications, media or multimedia messaging, conferencing, desktop sharing, file sharing, and presence services (e.g., presence on instant messaging, presence on a Web portal, presence on a conference, Session Initiation Protocol or SIP presence, and the like). The communication applications may also reside on a user's communication device 108.

The calendar server 128 can employ a calendar application 132 that maintains schedules of various users or enterprise subscribers in the system 100. The calendar application 132 may be accessed by each of the communication devices 108 separately to view a particular user's calendar. A user can access the calendar application 132 to determine the availability for himself/herself as well as other participants.

The calendar application normally provides, in a monthly and yearly calendar format, multiple time slots of determined duration (e.g., 15 or 30 minutes) in each hour of each day. Meetings may be scheduled to occupy one or more of the time slots. A typical meeting is set up by a meeting organizer emailing invitations to selected meeting invitees. A typical invitation or invite includes various fields, such as meeting subject, meeting location, meeting start time, meeting end time, and whether the meeting is an all-day event. The invite status is maintained for each invitee to indicate whether the meeting is accepted unconditionally, accepted tentatively, declined, or countered with a proposed new time.

Each user's schedule may be stored on the calendar server 128 or in the database 140 in association with or linked to an identity, electronic address, and/or profile of the user or enterprise subscriber. When a user wants to view or retrieve information related to his/her or another participant's schedule, the calendar application 132 can retrieve the requested schedule and provide the same to the requesting user. The calendar application 132 is useful for determining a participant's availability at some point in the future. Based on the availability of a participant at some point in the future, a meeting may be scheduled using the calendar application 132. In some embodiments, the communication server 120 and the calendar server 128 may be the same server.

The database server 138, which is typically a database management system, and database 140 manage enterprise information. Enterprise information typically refers to any information used, developed, or resulting from the enterprise in its ordinary course of business. Examples of enterprise information include an enterprise directory (e.g., user profiles, roles, and preferences such as user identifier, user name (first, last, and/or middle name), location, address, contact electronic addresses for a variety of media (such as email, instant messaging, SIP, workplace phone, home phone, and cellular phone), preferred contact medium for different times of day (such as weekdays 8 am to 5 pm: work phone, 5 pm to 8 pm: cellular phone, 8 pm to 8 am: home phone; weekends: cell phone), sessions in which the user is a participant and/or invitee (e.g., by session identifier, name, and type), session related information (such as responses to invitations and user role whether host or participant), and user job description, expertise, qualifications, experience, skills, and/or title), inanimate and/or animate enterprise resources available for conferences or meetings (such as desktop sharing services and access information related thereto, conference room and/or office identifications, locations, sizes (capacities), and availabilities, conference bridge information (such as bridge access information), catering and/or conference room setup information (e.g., internal and/or external resources for providing food and/or drinks for a meeting), heating, ventilation and air conditioning (“HVAC”) resources, lighting resources, security resources, information technology resources, and conference room accessory devices (such as a projector, projection screen, computer, video recorder, video player, video conferencing equipment, and other audio and/or visual equipment, parking spaces, and furniture (e.g., tables and chairs))), enterprise documents, client or customer, manufacturing, product, inventory, service, marketing, and sales information, and enterprise rules.

Enterprise rules generally refer to business rules, policies, goals, best practices, SOPs, legal considerations and/or requirements, and other requirements. While there are a vast number of types of enterprise rules, enterprise rules pertinent to this disclosure generally regulate, require, prohibit, or otherwise control interpersonal interactions, such as between, on the one hand, an employee, consultant, or other enterprise representative with, on the other hand, a client and/or customer, another enterprise employee, consultant, or other enterprise representative. Exemplary rules regulate, require, prohibit, stipulate, or otherwise control who is required and optional to be present during the meeting, required and optional meeting location(s) and/or timing, conduct of meeting (such as whether or not the meeting is to be recorded, participant seating requirements (e.g., who is to set where), and designated participant roles for meeting (such as who is to lead the meeting)), required and optional meeting media and multimedia materials (e.g., exhibit, video, and document), available, required and optional enterprise inanimate resources for the meeting (e.g., what bridge is to be used, what telephone number is to be used, and what conference room is to be used), access to and use of enterprise animate and inanimate meeting resources, and prerequisites for the meeting (such as a signed confidentiality or nondisclosure agreement).

The meeting manager 136 receives requests to configure or otherwise detects a meeting instance, interacts with the meeting organizer to determine and/or collect relevant information about the meeting, accesses, interprets, identifies, and applies relevant enterprise rules to the collected information, and configures itself and/or assists the meeting organizer in configuring the meeting in accordance with relevant enterprise rules.

The resource manager 112 maintains records regarding, tracks current and scheduled use of, controls access to, resolves scheduling conflicts regarding, and otherwise manages enterprise resources. Typically, the managed enterprise resources are inanimate resources, though it may also manage animate resources. Examples of inanimate resources include conference rooms, conference bridges, conference room accessory devices (such as a projector, projection screen, computer, video recorder, video player, and video conferencing equipment), enterprise documents and other written materials, software applications (such as desktop sharing services), and the like. Examples of animate resources include enterprise employees, consultants, or other enterprise representatives.

The resource manager 112, meeting manager 136, database server 138, communication server 120, and calendar server 128 can be connected to the communication network 104 via a trusted local area network 180, which is protected by a demilitarized zone (“DMZ”) or other perimeter network from an untrusted communication network 104, such as the Internet. As will be appreciated, a DMZ is a physical or logical subnetwork that contains and/or exposes an enterprise's external-facing services to a larger untrusted network, usually the Internet. The DMZ adds an additional layer of security to an organization's local area network. An external attacker only has access to equipment in the DMZ, rather than any other part of the local area network. A DMZ is typically implemented using one or more firewalls.

It should be emphasized that the configuration of the servers 112, 120, and 128, user communication devices 108, and other elements as shown in FIG. 1 is for purposes of illustration only and should not be construed as limiting the invention to any particular arrangement of elements.

The system 100 combines the calendar server 128 and calendar application 132 or other scheduling system with enterprise rule application to align, at setup or thereafter, the meeting with applicable enterprise rules. Alignment concerns not only optional and required meeting invitees but also configuration parameters. Examples include stipulating which conferencing bridge to use (e.g., some meetings may need to be recorded according to enterprise rules and thus a recording conference bridge would be used), which phone number to use (e.g., for a meeting with a customer a toll-free telephone number may need to be used whereas a meeting with employees might be issued with a local telephone number), that, as a precondition to the meeting, the parties must receive, review, and/or consummate a preliminary agreement (e.g., for a meeting with a customer, a non-disclosure or confidentiality agreement may need to be sent to the customer with the provision that the customer must acknowledge receipt, review, and/or sign the agreement before the meeting can commence), that face-to-face meetings must require certain equipment (e.g., a video recording system for late auditing the meeting), and that mandatory and/or optional reading materials must be reviewed as preparation for the meeting.

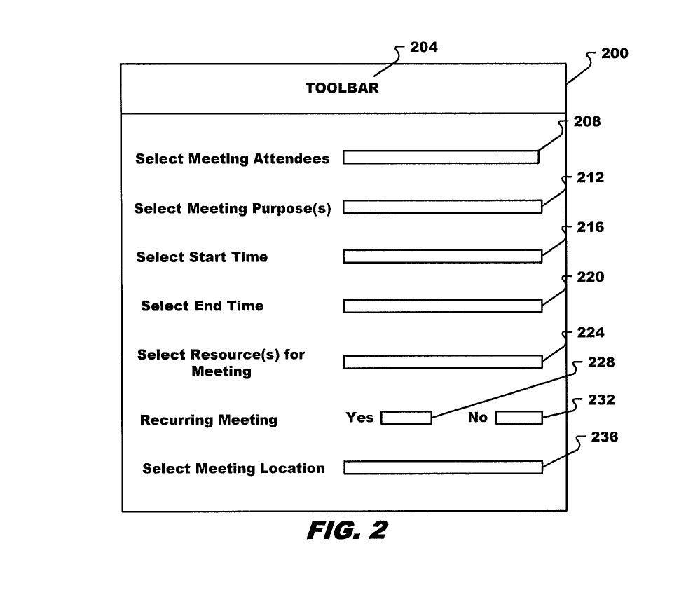

FIG. 2 shows a screenshot 200 of a display provided, by the meeting manager 136, to a meeting organizer during meeting setup or modification. The display includes a toolbar 204, including software tools such as “save and close” to save and close a scheduled activity, “invite attendees” to invite a potential meeting attendee, “calendar” to view the meeting organizer's electronic calendar, “delete” to delete a meeting occurrence, “forward” to forward the meeting invitation to an uninvited party, “appointment” to set up the meeting, “scheduling assistant” to view calendars of the various invitees to select an appropriate meeting time, “meeting organizer status” (e.g., free, tentative, busy, and out of office), “reminder time interval” (e.g., 15 minutes before meeting commences), “recurrence” to make the meeting a recurring meeting, “time zones” to show the meeting time in another time zone, “meeting category” to indicate type of meeting, “private” to indicate that the meeting is not to be published to others, “high importance” flag to indicate that the meeting is urgent, and “low importance” flag to indicate that the meeting is of low importance.

The display further includes other fields to be populated by the meeting organizer and/or meeting manager 136. The select meeting attendee field 208 can provide the meeting organizer with a list of required and/or optional meeting attendees and/or include a wildcard for a meeting attendee to be entered by the meeting organizer. The select meeting purpose(s) field 212 can provide the meeting organizer with a list of possible meeting purposes and/or include a wildcard for a meeting purpose to be entered by the meeting organizer. The required and/or optional meeting attendee and meeting purposes listings can be preconfigured or preselected or stipulated by one or more enterprise rules. The select start time and select end time fields 216 and 220, respectively, stipulate the meeting start and end times. These times may be entered freely by the meeting organizer and/or be selected by the meeting organizer or preselected by the meeting manager based on one or more enterprise rules. The select resource(s) for meeting field 224 stipulates what enterprise (inanimate) resources are to required, optional, or meeting organizer selected for the meeting. The recurring meeting fields 228 and 232 indicate whether or not the meeting is recurring. Finally, the select meeting location field 236 stipulates what meeting location is required, optional, or meeting organizer selected for the meeting.

The process for setting up a meeting may collect information from the meeting organizer first followed by application of enterprise rules to modify the meeting configuration. Alternatively, the process may collect some information from the meeting organizer first, followed by application of enterprise rules to provide required or suggested changes to the meeting configuration, and finalized by the meeting organizer by accepting or declining suggestions. Other combinations are also possible as will be appreciated by one of ordinary skill in the art based upon this disclosure.

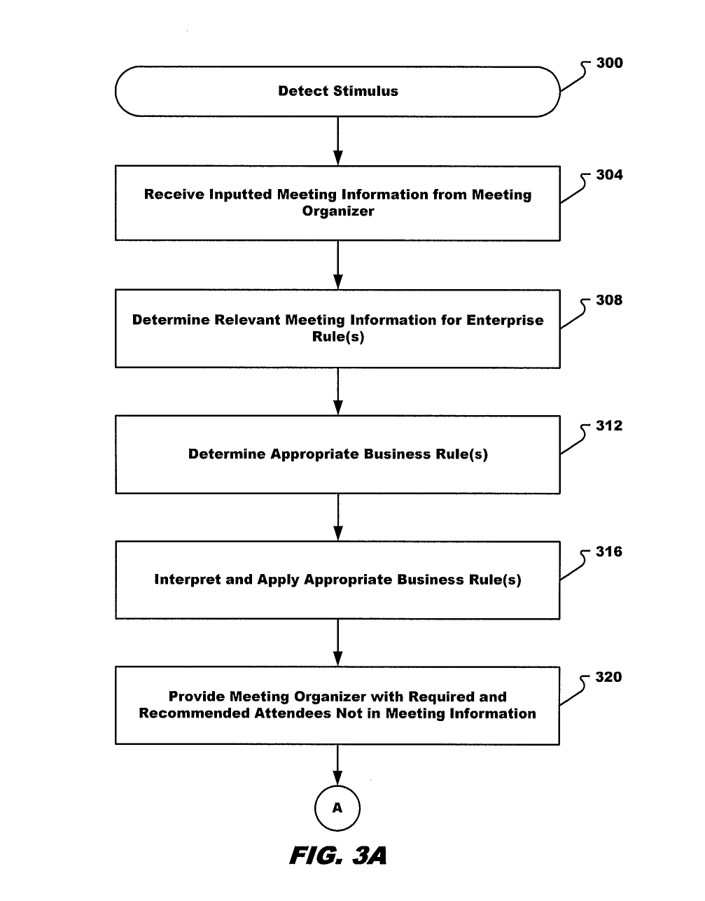

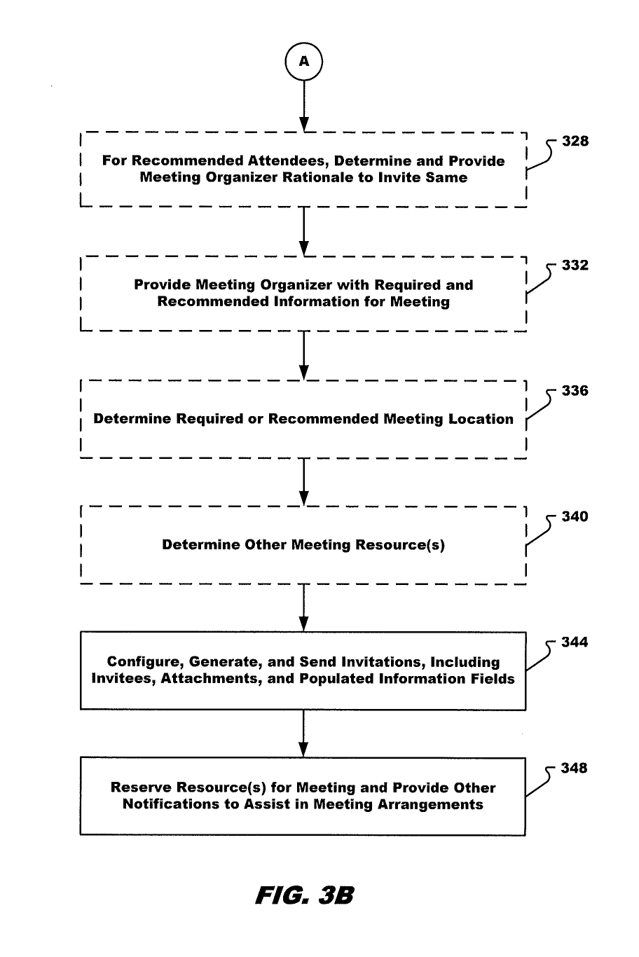

Referring to FIGS. 3A-B, a process according to this disclosure will be discussed.

In step 300 (FIG. 3A), the meeting manager 136 detects a stimulus to initiate operation. The stimulus can be a meeting organizer request, an attempt by a meeting organizer to set up a meeting on his or her electronic calendar, identifying a meeting already set up by a meeting organizer, and the like. The meeting manager 136 can access, via the database server 138, the electronic calendars of the enterprise employees, consultants, and other representatives and identify meetings not previously analyzed by the meeting manager 136.

In step 304, the meeting manager 136 receives inputted meeting information from the meeting organizer. This can, for instance, be any of the information shown in the display of FIG. 2. The meeting manager 136 commonly first determines the purpose of the meeting prior to enterprise rule retrieval. This can be effected by providing the meeting organizer with a list of possible meeting purposes with a wildcard to receive a user inputted purpose. Examples of meeting purposes include sales, marketing, service, employee discharge, employee discipline, contract negotiation, business strategy, board action, management, merger/acquisition, finance, accounting, legal, and the like.

In step 308, the meeting manager 136 determines relevant meeting information for selection of enterprise rules, and, in step 312, identifies and selects relevant enterprise rules to apply to the proposed meeting.

In step 316, the meeting manager 136 accesses (via the database server 138 from the database 140), interprets, and applies relevant enterprise rules to the collected information. For example, the meeting manager 136 can include an enterprise rule execution engine that interprets the received rules and, as shown in later steps, acts upon them by stepping the meeting organizer through a stepwise wizard.

In step 320, the meeting manager 136 provides the meeting organizer with required and recommended attendees not received in step 304. The meeting manager 136 may display a subset of all possible meeting invitees that are required to attend the meeting. The subset can primarily be taken from an enterprise directory but can include external resources, such as a law firm that the enterprise works with to ensure proper legal compliance or a business partner that can provide could and security experts. The meeting organizer has to pick one or more invitees from the subset before the meeting manager 136 allows the meeting organizer to proceed to step 324.

In optional step 328 (FIG. 3B), the meeting manager 136 determines, for recommended and/or optional attendees, and presents to the meeting organizer a rationale for selecting one or more of the recommended or optional attendees. The meeting manager 136 can display a subset of all possible meeting invitees who are considered important or valuable additions to the meeting roster but are not mandatory. The meeting organizer can choose to decline inviting anybody from the list but the meeting manager 136 will show a rationale why it might be a good idea to pick one or more invitees from the list. The meeting manager 136 can require the meeting organizer to provide a rationale for not selecting one or more recommended or optional attendees.

In optional step 332, the meeting organizer 136 provides the meeting organizer with required and/or recommended information (e.g., documents, attachments, exhibits, and the like) for the meeting. This can be done by providing the meeting organizer with a list of required information (use of which is mandatory) and/or list of recommended information. As noted above in connection with attendees, the meeting manager 136 can determine, for recommended or optional information, and present to the meeting organizer a rationale for selecting one or more of the listed recommended or optional information.

In optional step 336, the meeting manager 136 determines a required or recommended meeting location. This can be done by providing the meeting organizer with a list of required meeting locations (use of one of which is mandatory) and/or list of recommended meeting locations. As noted above in connection with attendees, the meeting manager 136 can determine, for recommended or optional meeting locations, and present to the meeting organizer a rationale for selecting one or more of the listed recommended or optional meeting locations.

In optional step 340, the meeting manager 136 determines other enterprise resources that are required and/or recommended. This can be done by providing the meeting organizer with a list of required resources (use of one or more of which is mandatory) and/or list of recommended resources. As noted above in connection with attendees, the meeting manager 136 can determine, for recommended or optional resource, and present to the meeting organizer a rationale for selecting one or more of the listed recommended or optional resources.

In step 344, the meeting manager 136, based on the meeting organizer provided information and enterprise rule requirements, automatically configures, generates, and sends invitations to each invitee. The meeting timing can be modified based on required and/or selected enterprise (inanimate) resource information provided by the resource manager 112. The resource manager 112, for example, can notify the meeting organizer that a required and/or selected enterprise (inanimate) resource is unavailable at the desired meeting time (e.g., due to a prior reservation) and recommend an alternate meeting time permitted by enterprise rules and schedules of meeting invitees (which is provided by the scheduling assistant) and the availability of other required and/or selected enterprise (inanimate) resources. The invitations include mandatory and selected optional attachments and other populated information fields, such as start and end times, meeting location and purpose, meeting invitees, and other information. For instance, the meeting manager 136, using information supplied by the resource manager 112, can select a conference bridge and conference bridge phone number and access code for the meeting and include the information in a comments or notes field. The meeting manager 136 can configure the invite in accordance with one or more enterprise rules, such as by adding a legal disclaimer to the meeting invite email. The meeting manager 136 can also provide the meeting organizer and/or invitees in the invite choices of mandatory, suggested, and/or optional meeting preparatory materials (e.g., documentation, training documents, and the like).

In step 348, the meeting manager 136 reserves enterprise resources, such as a conference room and meeting accessories, for the meeting and provides other notifications to assist in meeting arrangements. Enterprise resources are typically reserved automatically by requesting the resource manager 112 to reserve any required and/or selected enterprise (inanimate) resources. The other notifications can be provided to a staff member, such as a secretary or assistant, to prepare the conference room prior to the meeting, a travel agent to contact one or more meeting attendees to handle travel and lodging arrangements, and the like.

The exemplary systems and methods of this disclosure have been described in relation to a networked architecture. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a server, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

For example in one alternative embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
determining, by a microprocessor executable meeting manager, that a meeting is currently or will be scheduled by a meeting organizer;
applying, by the microprocessor executable meeting manager, one or more enterprise rules to determine one or more of (a) a required and/or recommended invitee, (b) a scheduling parameter for the meeting, and (c) an enterprise resource for the meeting; and
requiring and/or requesting, by the microprocessor executable meeting manager, that the meeting be scheduled to include the one or more of (a) a required and/or recommended invitee, (b) a scheduling parameter for the meeting, and (c) an enterprise resource for the meeting.

2. The method of claim 1, wherein the one or more of (a) a required and/or recommended invitee, (b) a scheduling parameter for the meeting, and (c) an enterprise resource for the meeting is the required and/or recommended invitee and wherein one or more the enterprise rules is one or more of a business rule, policy, goal, best practice, standard operating procedure, and legal consideration and/or requirement.

3. The method of claim 1, wherein the one or more of (a) a required and/or recommended invitee, (b) a scheduling parameter for the meeting, and (c) an enterprise resource for the meeting is the scheduling parameter for the meeting, wherein the scheduling parameter is one or more of a required and optional meeting location, timing of meeting, conduct of meeting, and prerequisite for the meeting, and wherein the one or more enterprise rules is one or more of a business rule, policy, goal, best practice, standard operating procedure, and legal consideration and/or requirement.

4. The method of claim 1, wherein the one or more of (a) a required and/or recommended invitee, (b) a scheduling parameter for the meeting, and (c) an enterprise resource for the meeting is the enterprise resource for the meeting, wherein the enterprise resource is one or more of inanimate enterprise resources available for conferences or meetings, and wherein the one or more the enterprise rules regulate, require, prohibit, or otherwise control an interpersonal interaction.

5. The method of claim 4, wherein the enterprise resource is one or more of a required and/or optional enterprise media and multimedia material, desktop sharing service, conference room, office, conference bridge, catering service, conference room setup service, heating, ventilation, and/or air conditioning resource, lighting resource, security resource, information technology resource, and conference room accessory device, parking space, and furniture.

6. The method of claim 1, wherein the microprocessor executable meeting manager determines the one or enterprise rules meeting that apply to the meeting that is currently or will be scheduled based on a purpose of the meeting, and wherein the microprocessor executable meeting manager provides the meeting organizer with one or more of a required and/or optional meeting invitee, a list of potential purposes for the meeting, a required and/or optional start and/or end time for the meeting, a required and/or optional inanimate enterprise resource for the meeting, and a required and/or optional location for the meeting.

7. The method of claim 1, wherein the meeting organizer is required to provide a rationale for not selecting the one or more of (a) a required and/or recommended invitee, (b) a scheduling parameter for the meeting, and (c) an enterprise resource for the meeting and/or the microprocessor executable meeting manager provides the meeting organizer with a rationale for selecting the one or more of (a) a required and/or recommended invitee, (b) a scheduling parameter for the meeting, and (c) an enterprise resource for the meeting.

8. A system, comprising:
a microprocessor executable meeting manager operable to:
determine that a meeting is currently or will be scheduled by a meeting organizer;
apply one or more enterprise rules to determine one or more of (a) a required and/or recommended invitee, (b) a scheduling parameter for the meeting, and (c) an enterprise resource for the meeting; and
require and/or request the meeting be scheduled to include the one or more of (a) a required and/or recommended invitee, (b) a scheduling parameter for the meeting, and (c) an enterprise resource for the meeting.

9. The system of claim 8, wherein the one or more of (a) a required and/or recommended invitee, (b) a scheduling parameter for the meeting, and (c) an enterprise resource for the meeting is the required and/or recommended invitee and wherein one or more the enterprise rules is one or more of a business rule, policy, goal, best practice, standard operating procedure, and legal consideration and/or requirement.

10. The system of claim 8, wherein the one or more of (a) a required and/or recommended invitee, (b) a scheduling parameter for the meeting, and (c) an enterprise resource for the meeting is the scheduling parameter for the meeting, wherein the scheduling parameter is one or more of a required and optional meeting location, timing of meeting, conduct of meeting, and prerequisite for the meeting, and wherein the one or more enterprise rules is one or more of a business rule, policy, goal, best practice, standard operating procedure, and legal consideration and/or requirement.

11. The system of claim 8, wherein the one or more of (a) a required and/or recommended invitee, (b) a scheduling parameter for the meeting, and (c) an enterprise resource for the meeting is the enterprise resource for the meeting, wherein the enterprise resource is one or more of inanimate enterprise resources available for conferences or meetings, and wherein the one or more the enterprise rules regulate, require, prohibit, or otherwise control an interpersonal interaction.

12. The system of claim 11, wherein the enterprise resource is one or more of a required and/or optional enterprise media and multimedia material, desktop sharing service, conference room, office, conference bridge, catering service, conference room setup service, heating, ventilation, and/or air conditioning resource, lighting resource, security resource, information technology resource, and conference room accessory device, parking space, and furniture.

13. The method of claim 8, wherein the microprocessor executable meeting manager is operable to determine the one or enterprise rules meeting that apply to the meeting that is currently or will be scheduled based on a purpose of the meeting, and wherein the microprocessor executable meeting manager is operable to provide the meeting organizer with one or more of a required and/or optional meeting invitee, a list of potential purposes for the meeting, a required and/or optional start and/or end time for the meeting, a required and/or optional inanimate enterprise resource for the meeting, and a required and/or optional location for the meeting.

14. The system of claim 8, wherein the meeting organizer is required to provide a rationale for not selecting the one or more of (a) a required and/or recommended invitee, (b) a scheduling parameter for the meeting, and (c) an enterprise resource for the meeting and/or the microprocessor executable meeting manager is operable to provide the meeting organizer with a rationale for selecting the one or more of (a) a required and/or recommended invitee, (b) a scheduling parameter for the meeting, and (c) an enterprise resource for the meeting.

15. A tangible and non-transient computer readable medium comprising microprocessor executable instructions that, when executed, perform operations comprising:
determine that a meeting is currently or will be scheduled by a meeting organizer;
apply one or more enterprise rules to determine one or more of (a) a required and/or recommended invitee, (b) a scheduling parameter for the meeting, and (c) an enterprise resource for the meeting; and
require and/or request the meeting be scheduled to include the one or more of (a) a required and/or recommended invitee, (b) a scheduling parameter for the meeting, and (c) an enterprise resource for the meeting.

16. The computer readable medium of claim 15, wherein the one or more of (a) a required and/or recommended invitee, (b) a scheduling parameter for the meeting, and (c) an enterprise resource for the meeting is the required and/or recommended invitee and wherein one or more the enterprise rules is one or more of a business rule, policy, goal, best practice, standard operating procedure, and legal consideration and/or requirement.

17. The computer readable medium of claim 15, wherein the one or more of (a) a required and/or recommended invitee, (b) a scheduling parameter for the meeting, and (c) an enterprise resource for the meeting is the scheduling parameter for the meeting, wherein the scheduling parameter is one or more of a required and optional meeting location, timing of meeting, conduct of meeting, and prerequisite for the meeting, and wherein the one or more enterprise rules is one or more of a business rule, policy, goal, best practice, standard operating procedure, and legal consideration and/or requirement.

18. The computer readable medium of claim 15, wherein the one or more of (a) a required and/or recommended invitee, (b) a scheduling parameter for the meeting, and (c) an enterprise resource for the meeting is the enterprise resource for the meeting, wherein the enterprise resource is one or more of inanimate enterprise resources available for conferences or meetings, and wherein the one or more the enterprise rules regulate, require, prohibit, or otherwise control an interpersonal interaction.

19. The computer readable medium of claim 18, wherein the enterprise resource is one or more of a required and/or optional enterprise media and multimedia material, desktop sharing service, conference room, office, conference bridge, catering service, conference room setup service, heating, ventilation, and/or air conditioning resource, lighting resource, security resource, information technology resource, and conference room accessory device, parking space, and furniture.

20. The computer readable medium of claim 15, wherein the microprocessor executable instructions are operable to determine the one or enterprise rules meeting that apply to the meeting that is currently or will be scheduled based on a purpose of the meeting, and wherein the microprocessor executable instructions are operable to provide the meeting organizer with one or more of a required and/or optional meeting invitee, a list of potential purposes for the meeting, a required and/or optional start and/or end time for the meeting, a required and/or optional inanimate enterprise resource for the meeting, and a required and/or optional location for the meeting.

21. The computer readable medium of claim 15, wherein the meeting organizer is required to provide a rationale for not selecting the one or more of (a) a required and/or recommended invitee, (b) a scheduling parameter for the meeting, and (c) an enterprise resource for the meeting and/or the microprocessor executable instructions are operable to provide the meeting organizer with a rationale for selecting the one or more of (a) a required and/or recommended invitee, (b) a scheduling parameter for the meeting, and (c) an enterprise resource for the meeting.
